(19) United States
(12) Patent Application Publication
(10) Pub. No.: US 2025/0119213 A1
(43) Pub. Date: Apr. 10, 2025

(54) MIMO Processing with LED based Reception of Optical Communication Signals

(71) Applicant: Telefonaktiebolaget LM Ericsson (publ), Stockholm (SE)

(72) Inventors: Athanasios Stavridis, Malmö (SE); Rafael Puerta, Sundbyberg Stockholm (SE)

(21) Appl. No.: 18/868,040

(22) PCT Filed: Sep. 1, 2022
(86) PCT No.: PCT/EP2022/074307

§ 371 Date: Nov. 21, 2024

(30) Foreign Application Priority Data
May 31, 2022 (GR) 20220100453

(51) Int. Cl. H04B 10/116; H04B 10/114

(52) U.S. Cl. CPC H04B 10/116; H04B 10/1143; H04B 10/1149

(57) ABSTRACT

A wireless communication device (200), which is equipped with a photodetector (202) and a light-emitting diode (201), detects a first electrical response of the light-emitting diode (201) to an optical communication signal and a second electrical response of the photodetector (202) to the optical communication signal. Based on the detected first electrical response and the detected second electrical response, the wireless communication device (210) performs Multiple-Input Multiple-Output reception processing to receive data from at least one further wireless communication device (210).

### TECHNICAL FIELD

The present invention relates to methods for controlling optical wireless communication and to corresponding devices, systems, and computer programs.

### BACKGROUND

Optical wireless communication, also denoted as light communication (LC), is expected to have potential to become a new means of indoor wireless communication. Such LC technologies may be based on visible light or infrared light. It is expected that an LC system can achieve a throughput of Gigabits per second. Typically LC technologies are based on communicating binary data using rapidly varying levels of light intensity. For example, one or multiple Light Emitting Diodes (LEDs) are provided in a transmitting device in order to modulate binary data in different levels of emitted light intensity. The levels of the emitted light typically intensity are changed at rates that are not perceivable by the human eye. A receiver may detect the changes of the emitted light intensity, e.g., using Photo Detectors (PDs). In this way, the receiver is able to detect the transmitted binary data.

Due to the nature of optical transmitters and receivers, an LC system typically uses Intensity Modulation (IM) with Direct Detection (DD), in the following denoted as IM-DD, see for example “Wireless Infrared Communications” by J. M. Kahn and J. R. Barry, Proc. IEEE, vol. 85, no. 2, pp. 265-298, February 1997. This means that the transmitted/received signal is real and strictly positive.

In “Performance Evaluation of Space Modulation Techniques in VLC Systems” by A, Stavridis et al., 2015 IEEE International Conference on Communication Workshop (ICCW), June 2015, it is suggested that performance of an VLC (Visible Light Communication) system can be enhanced by using MIMO (Multiple Input Multiple Output) techniques. However, such enhancements typically require addition of further LEDs and PDs, which increases device complexity and may also be difficult to implement in devices with small form factor.

In view of the above, there is a need for techniques which allow for efficiently improving performance of an LC communication system.

### SUMMARY

According to an embodiment, a method of controlling wireless communication is provided. According to the method, a wireless communication device, which is equipped with a PD and an LED, detects a first electrical response of the LED to an optical communication signal and a second electrical response of the PD to the optical communication signal. Based on the detected first electrical response and the detected second electrical response, the wireless communication device performs MIMO reception processing to receive data from at least one further wireless communication device.

According to a further embodiment, a method of controlling wireless communication is provided. According to the method, a wireless communication device, which is equipped with multiple LEDs, detects, for each of the LEDs, a respective electrical response of the LED to an optical communication signal. The electrical response is based on detecting a time-varying impulse response generated by discharging of an internal capacitance of the LED according to a monotonic function of time. Further, the wireless communication device linearizes each of the detected electrical responses by respectively applying an inverse of the monotonic function to the time-varying impulse response. Based on the linearized electrical responses, the wireless communication device performs Multiple Input and Multiple Output, MIMO, reception processing to receive data from a further wireless communication device.

According to a further embodiment, a wireless communication device is provided. The wireless device comprises a PD and an LED. The wireless communication device is configured to detect a first electrical response of the LED to an optical communication signal and a second electrical response of the PD to the optical communication signal. Further, the wireless communication device is configured to, based on the detected first electrical response and the detected second electrical response, perform MIMO reception processing to receive data from a further wireless communication device.

According to a further embodiment, a wireless communication device is provided. The wireless device comprises a PD and an LED. Further, the wireless communication device comprises at least one processor and a memory. The memory contains instructions executable by said at least one processor, whereby the wireless communication device is operative to detect a first electrical response of the LED to an optical communication signal and a second electrical response of the PD to the optical communication signal. Further, the memory contains instructions executable by said at least one processor, whereby the wireless communication device is operative to, based on the detected first electrical response and the detected second electrical response, perform MIMO reception processing to receive data from a further wireless communication device.

According to a further embodiment, a wireless communication device is provided. The wireless device comprises multiple LEDs. The wireless communication device is configured to detect, for each of the LEDs, a respective electrical response of the LED to an optical communication signal. The electrical response is based on detecting a time-varying impulse response generated by discharging of an internal capacitance of the LED according to a monotonic function of time. Further, the wireless communication device is configured to linearize each of the detected electrical responses by respectively applying an inverse of the monotonic function to the time-varying impulse response. Further, the wireless communication device is configured to, based on the linearized electrical responses, perform MIMO reception processing to receive data from a further wireless communication device.

According to a further embodiment, a wireless communication device is provided. The wireless device comprises a PD and an LED. Further, the wireless communication device comprises at least one processor and a memory. The memory contains instructions executable by said at least one processor, whereby the wireless communication device is operative to detect, for each of the LEDs, a respective electrical response of the LED to an optical communication signal. The electrical response is based on detecting a time-varying impulse response generated by discharging of an internal capacitance of the LED according to a monotonic function of time. Further, the memory contains instructions executable by said at least one processor, whereby the wireless communication device is operative to linearize each of the detected electrical responses by respectively applying an inverse of the monotonic function to the time-varying impulse response. Further, the memory contains instructions executable by said at least one processor, whereby the wireless communication device is operative to, based on the linearized electrical responses, perform MIMO reception processing to receive data from a further wireless communication device.

According to a further embodiment, a computer program or computer program product is provided, e.g., in the form of a non-transitory storage medium, which comprises program code to be executed by at least one processor of a wireless communication device, which is equipped with a PD and an LED. Execution of the program code causes the wireless communication device to detect a first electrical response of the LED to an optical communication signal and a second electrical response of the PD to the optical communication signal. Further, execution of the program code causes the wireless communication device to, based on the detected first electrical response and the detected second electrical response, perform MIMO reception processing to receive data from at least one further wireless communication device.

According to a further embodiment, a computer program or computer program product is provided, e.g., in the form of a non-transitory storage medium, which comprises program code to be executed by at least one processor of a wireless communication device, which is equipped with multiple LEDs, is provided. Execution of the program code causes the wireless communication device to detect, for each of the LEDs, a respective electrical response of the LED to an optical communication signal. The electrical response is based on detecting a time-varying impulse response generated by discharging of an internal capacitance of the LED according to a monotonic function of time. Further, execution of the program code causes the wireless communication device to linearize each of the detected electrical responses by respectively applying an inverse of the monotonic function to the time-varying impulse response. Further, execution of the program code causes the wireless communication device to, based on the linearized electrical responses, perform Multiple Input and Multiple Output, MIMO, reception processing to receive data from a further wireless communication device.

Details of such embodiments and further embodiments will be apparent from the following detailed description of embodiments.

### BRIEF DESCRIPTION OF THE DRAWINGS

FIG. 1 schematically illustrates an example of a scenario where optical wireless communication is controlled according to an embodiment.

FIG. 2A shows a block diagram for schematically illustrating an example of optical channels as considered according to an embodiment.

FIG. 2B shows a block diagram for schematically illustrating a further example of optical channels as considered according to an embodiment.

FIG. 2C shows a block diagram for schematically illustrating a further example of optical channels as considered according to an embodiment.

FIG. 3 schematically illustrates an example of reception processing of optical communication signals according to an embodiment.

FIG. 4 schematically illustrates a further example of reception processing of optical communication signals according to an embodiment.

FIG. 5 shows a flowchart for schematically illustrating a method according to an embodiment.

FIG. 6 shows a flowchart for schematically illustrating a further method according to an embodiment.

FIG. 7 schematically illustrates structures of a wireless communication device according to an embodiment.

### DETAILED DESCRIPTION OF EMBODIMENTS

In the following, concepts in accordance with exemplary embodiments of the invention will be explained in more detail and with reference to the accompanying drawings. The illustrated embodiments relate to controlling of optical wireless communication (OWC), e.g., based on an LC technology utilizing light in the visible and/or infrared spectrum.

In the illustrated concepts, the performance of OWC by a wireless communication device may be increased in an efficient manner by using one or more LEDs for reception of MIMO OWC signals. In some scenarios, the MIMO OWC signals may be received by at least one PD and at least one LED. In other scenarios, the MIMO OWC signals may be received by multiple LEDs. In each case, efficiency may be improved, because an LED which is used for sending outgoing MIMO OWC signals may also be used for receiving incoming MIMO OWC signals. MIMO capabilities of the wireless communication device may thus be enhanced by enabling more MIMO channels without requiring additional PDs. Further, using one or more LEDs of the device as receiver for the OWC signals may also increase the field of view of the wireless communication device, i.e., enlarge the area from which the wireless communication device can receive the OWC signals with LoS (line-of-sight) conditions. For accurate MIMO reception processing of the MIMO OWC signals received by the LED(s), an electrical response of the LED(s) to the MIMO OWC signal may be linearized.

In a conventional optical MIMO OWC system, optical power reception would be done by multiple receiving PDs. Consequently, the potential MIMO reception gain is limited by the number of the receiving PDs and the geometry of the PD arrangement. In the illustrated concepts, one or more LEDs may be used for receiving the MIMO OWC signals. Since in a bi-directionally communication wireless communication device such LED(s) may anyway be present to be used as transmitter of outgoing OWC signals, a need to add additional components to the wireless communication device may be avoided. The LED(s) may be used jointly with the PD(s) for reception of the MIMO OWC signals. The latter benefits may be particularly relevant if the wireless communication device is an IoT (Internet of Things) device or some other device having a small form factor, where the installation of additional PDs might be problematic due to a limitation on size and/or due to complexity restrictions. In fact, many existing or future devices may anyway be equipped with one or more LED(s), and such existing LED(s) can be efficiently utilized as receiver for the MIMO OWC signals.

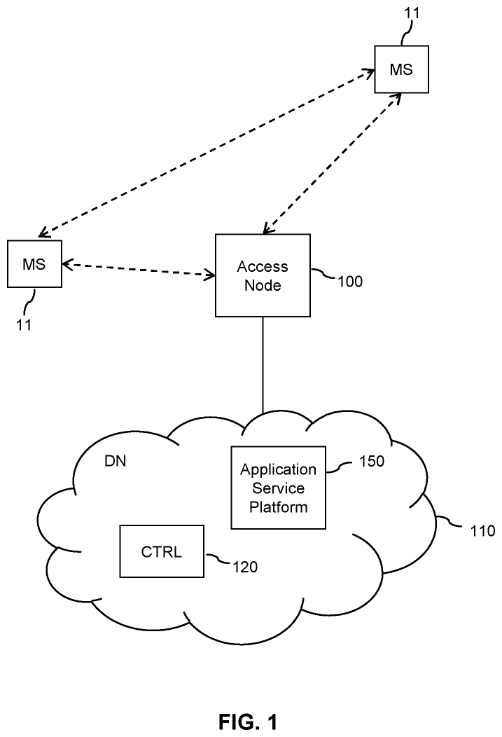

FIG. 1 schematically illustrates an example of a scenario where OWC is controlled in accordance with the illustrated concepts. Specifically, FIG. 1 illustrates a wireless communication network environment which is, at least in part, based on utilization of OWC. It is noted that the wireless communication network could additionally also support one or more other wireless communication technologies, e.g., a Wireless Local Area Network (WLAN) technology and/or a cellular communication technology as for example specified by 3GPP (3^{rd} Generation Partnership Project). In the example of FIG. 1, the wireless communication network includes an access node 100 and a number of mobile stations (MSs) 11. As illustrated by broken arrows, each MS 11 may use OWC signals to connect to the access node 100. Further, it is also possible that two MSs 11 use OWC signals to connect directly to each other. The OWC signals may thus be used to establish one or more OWC links. The OWC may be bi-directional. Accordingly, each MS 11 and the access node 100 may both transmit outgoing OWC signals and receive incoming wireless communication signals. OWC signals transmitted from the access node 100 to one of the MSs 11 may also be referred to as downlink (DL) OWC signals. OWC signals transmitted from one of the MSs 11 to the access node 100 may also be referred to as downlink (UL) OWC signals. OWC signals transmitted between two MSs 11 may also be referred to as device-to-device (D2D) OWC signals. At least some of these OWC signals may be MIMO OWC signals subject to MIMO reception processing in accordance with the illustrated concepts.

Based on DL and UL MIMO OWC signals subject to MIMO reception processing in accordance with the illustrated concepts, the access node 100 may provide data connectivity of the MSs 11 among each other and/or with respect to a data network (DN) 110. In this way, the access node 100 may also provide data connectivity of a given MS 11 other entities, e.g., to one or more servers, service providers, data sources, data sinks, user terminals, host computers, or the like. Accordingly, an OWC link established between a given MS 11 and the access node 100 may be used for providing various kinds of data services to the MS 11, e.g., a service related to industrial machine control. Such services may be based on applications which are executed on the MS 11 and/or on a device linked to the MS 11. By way of example, FIG. 1 illustrates an application service platform 150 provided in the DN 110. The application(s) executed on the MS 11 and/or on one or more other devices linked to the MS 11 may use the respective OWC link established by the MS 11 for data communication with one or more other MSs 11 and/or the application service platform 150, thereby enabling utilization of the corresponding service(s) at the MS 11. As further illustrated, the DN 110 includes a control node 120, which may be used for controlling and otherwise coordinating operation of the access node 100 and MSs 11.

It is noted that the wireless communication network may also include additional access nodes in order to enhance wireless coverage of the wireless communication network. Each of such access nodes may operate as explained for the access node 100 to provide data connectivity to one or more connected MSs.

The utilization of the LED(s) as receiver of the MIMO OWC signals may be based on principles as for example described in “LED-to-LED visible light communication networks”, by S. Schmid et al., Proceedings of the fourteenth ACM international symposium on Mobile ad hoc networking and computing (MobiHoc '13), July 2013. Accordingly, the operating principle of optical signal reception by the LED may rely on the speed at which an internal capacitance of the LED discharges while it does not transmit light and is charged in reverse bias. In more detail, when there is no light transmission from the LED, higher impinging intensity of light results in faster discharging. Consequently, an incoming intensity modulated optical signal can be measured based on the discharging speed of the LED. These principles of using an LED as a receiver of optical communication signals are also explained in “LED as Transmitter and Receiver of Light: A Simple Tool to Demonstration Photoelectric Effect” by G. Schirripa Spagnolo, F. Leccese, and M. Leccisi, Crystals, vol. 9, no. 10, pp. 1-17 (October 2019). Accordingly, in the illustrated concepts an intensity modulation of the incoming OWC signals can be detected based on the discharging rate of the LED(s). The operation of the LED(s) as receiver, and typically also as transmitter may thus be based on intensity-modulation (IM) and direct-detection (DD), in the following referred to as IM-DD operation.

Assuming an LED-PD link, where the LED and PD are placed in places for which the optical channel is non-zero, irrespective of the modulation form, the LED-PD link may be described by:

$${y}_{el}^{L E D - P D} = r {h}^{L E D - P D} x + {w}^{L E D - P D} , \qquad ( 1 )$$

where yₑₗ^{LED-PD} is the electrical response produced by the receiving PD, r is the responsivity of the PD, h^{LED-PD} is the optical wireless channel gain which includes both the optical propagation channel and the impulse response of the transmitting LED, x is the real-valued intensity modulated positive and non-zero transmitted optical signal, and w^{LED-PD} is a scalar which represents the composite effect of ambient shot and thermal noise.

As mentioned above, when using an LED as a receiver, the electrical response produced by the LED may be based on the discharging of the LED capacitance. Specifically, it can be assumed that during a transmission period Tₛ, e.g., corresponding to a modulation symbol, the LED capacitance discharges with a speed which depends on the collected light intensity. In more detail, during the k-th symbol period, (k−1)Tₛ≤t≤Tₛ, the discharge of the receiving LED produces a time-varying photo-current:

$${y}_{el}^{L E D - L E D} ( t ) = {g}_{L E D} ( t , {h}^{L E D - L E D} x ) + {w}^{LED - LED} \qquad ( 2 )$$

In relation (2), g_{LED}(t,h^{LED-LED}x) represents an analog front-end of the receiving LED, which transforms the collected optical power to the photocurrent yₑₗ^{LED-LED}(t) at time instant t. The photocurrent decreases as a function of time t. Such decrease may be described by a monotonic decreasing function of time t. In addition, h^{LED-LED} is the optical wireless channel between the two LEDs. It should be noted that, h^{LED-LED}, includes only the optical-wireless propagation channel between the two communicating LEDs. Also, x is the transmitted optical signal. Note that the exact form of, g_{LED}(.,.), depends on the specific implementation of the receiving LED and its associated circuitry. Furthermore, w^{LED-LED} represents any random noise or other type of jitter which may occur during the conversion of the received optical power to the corresponding electrical signal from the receiving LED and its associated circuitry. The noise and jitter, represented by, w^{LED-LED}, is additive as g_{LED}(.,.), is a monotonic function. Typically, w^{LED-LED} can be considered as a random variable. Its statistical description, in terms of a Probability Density Function (PDF), also depends on the particular electro-optical design of the receiving LED and its associated circuitry.

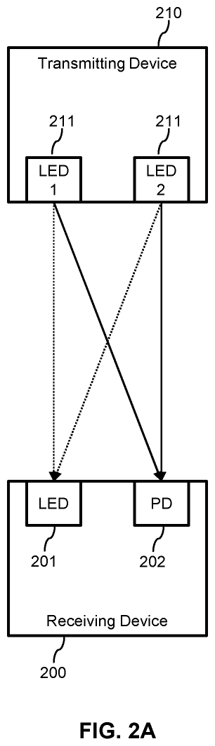

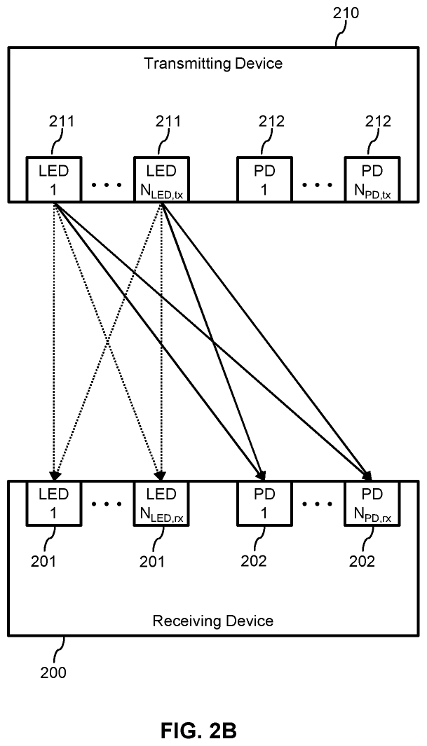

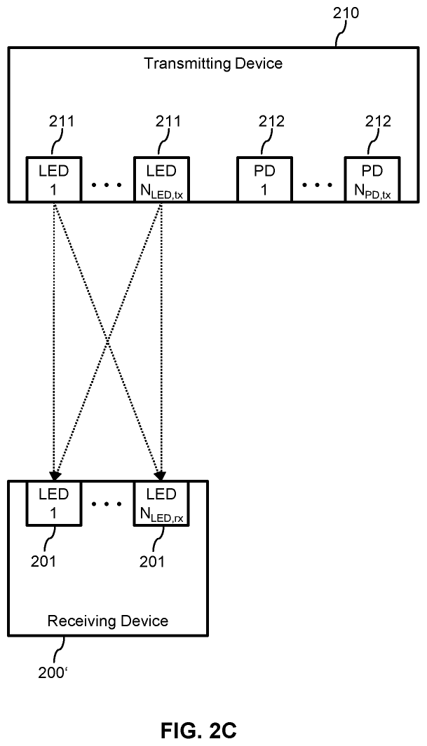

In the following, the MIMO reception processing according to the illustrated concepts will be further described in relation to a multi-LED and multi-PD OWC link. FIG. 2A illustrates an example of such multi-LED and multi-OWC OWC link. In the example of FIG. 2A, the receiving wireless communication device 200 is equipped with an LED 201 and a PD 202, and the transmitting wireless communication device 210 is equipped with two LEDs 211. FIG. 2B illustrates a more generic case, where the receiving wireless communication device 200 is equipped with N_{LED,rx} LEDs 201 and N_{PD,rx} PDs 202, while the transmitting wireless communication device 210 is equipped with N_{LED,tx} LEDs 211. As further illustrated, the transmitting wireless communication device 210 may also be equipped with N_{PD,tx} PDs 202. The example of FIG. 2A corresponds to N_{LED,rx}=2, N_{LED,tx}=2, N_{PD,rx}=0, and N_{PD,rx}=0. Based on relations (1) and (2), the MIMO system can be represented as:

$$[ \begin{matrix}{y}_{el}^{L E D - L E D} ( t ) \\ {y}_{el}^{P D}\end{matrix} ] = [ \begin{matrix}{g}_{L E D} ( t , {m}^{LED} {H}^{LED - LED} x \\ {r}^{PD} {H}^{LED - PD} x\end{matrix} ] + [ \begin{matrix}{w}^{LED - LED} \\ {w}^{L E D - P D}\end{matrix} ] , \qquad ( 3 )$$

where yₑₗ^{LED-LED}(t), is a Nᵣₓ^{LED}×1 vector with its i-th element being the electrical signal produced by the i-th receiving LED 201, and yₑₗ^{PD} is a Nᵣₓ^{PD}×1 vector with its i-th element being the electrical signal produced by the i-th receiving PD 202. It should be noted that, in accordance with relation (2), yₑₗ^{LED-LED}(t) is time varying for (k−1)Tₛ≤t≤Tₛ, and that such time variation is based on the function g_{LED}(.,.). As compared to that, yₑₗ^{PD} may be considered a time independent during the sampling period (k−1)Tₛ≤t≤Tₛ. Further, H^{LED-LED} is a N_{LED,rx}×N_{LED,tx} matrix with its (i,j) element representing the pure optical channel between the j-th transmitting LED 211 and the i-th receiving LED 201, not taking into account the impulse response of the transmitting LED 211 to its electrical input signal. Further, g(A)=[g(aᵢⱼ)], represents an element-wise application of the scalar monotonic function g_{LED}(.,.), as defined in relation (2), in every element of matrix A. Further, r^{PD} jointly represents various multiplicative factors between the transmitting LEDs 211 and the receiving PD(s) 202, for example including the impulse response of the transmitting LED 211 to its electrical input signal and the responsivity of the receiving PD 202. Further, H^{LED-PD} is an N_{PD,rx}×N_{LED,tx} matrix with its (i,j)-th element representing the pure optical channel between the j-th transmitting LED 211 and the i-th receiving PD 202, excluding the impulse response of the transmitting LED 211 to its electrical input signal. Further, w^{LED-LED} is a Nᵣₓ^{LED}×1 vector with its i-th element representing the random noise and any other type of jitter during the conversion of the received optical power to the corresponding electrical signal output from the i-th receiving LED 201 and its associated circuitry, and w^{LED-PD} is a Nᵣₓ^{PD}×1 vector with its i-th element representing the random noise during the conversion of the received optical power to the corresponding electrical signal output from the i-th PD 202.

It is noted that in relation (3) it is assumed that all the transmitting LEDs 211 have the same electro-optical characteristics. Similarly, it also is also assumed also that all the receiving LEDs 201 have the same electro-optical characteristics, and that all PDs 202 have the same electro-optical characteristics. On the other hand, the receiving optical characteristics of the LEDs 201 differ from the receiving optical characteristics of the PDs 202. It would however also be possible to consider more generic cases, where at least some of the receiving LEDs 201 have different electro-optical characteristics and/or at least some of the PDs 202 have different electro-optical characteristics.

In conventional Radio Frequency (RF) wireless communication, diversity gains are achieved by imposing signal redundancy in the frequency domain, time domain, and/or spatial domain. MIMO OWC as used in the illustrated concepts may increase redundancy of the optical signal in the receiving wireless communication device by jointly using both the LED(s) 201 and the PD(s) 202 for receiving the optical signal, thereby obtaining signal redundancy in the spatial domain. Considering that optical signals are susceptible to blockage by opaque objects, OWC is a technology which typically requires LoS conditions. The spatial redundancy may allow for mitigating potential loss of LoS conditions. Specifically, if a certain PD 202 loses LoS condition to certain transmitting LED 211, LoS condition may still exist for one or more receiving LEDs 201. Because the LED 201 and the PD 202 are at different positions on the receiving wireless communication device 200, the chances of having an unobstructed optical channel can be improved. Further, even in the case of a Non-Line-of-Sight (NLoS) channel, usage of the LED(s) 201 as additional reception point(s) helps to increase the collected optical power and thereby improve reception of the OWC signal. For example, the LED(s) 201 and the PD 202 could be used to implement an Angular Diversity Receiver (ADR). In such case, the usage of the LED(s) 201 as receiver may help to achieve a wider Field of View (FoV) of the ADR.

Further, usage of the LED(s) 201 as receiver may allow for obtaining multiplexing gains by forming multiple parallel symbol streams. The maximum number of parallel streams that when using only the PD(s) 202 as receiver is N_{PDs}=min(N_{tx,LED},N_{PD,rx}). If the number of the transmitting LEDs 211, N_{LED,tx}, is larger than the number of the receiving PDs 202, N_{PDs}, the number of the parallel streams is thus limited by the number of the PDs 202 in the receiving wireless communication device 200. If also one or more LEDs 201 of the receiving wireless communication device 200 are used for signal reception, more parallel streams than N_{PD,rx} may be supported.

Due to the time dependent photo-current associated by the discharging of the LED(s) 201, conventional MIMO reception processing algorithms cannot be directly applied to the electrical output signals of the LED(s) 201 and the PD(s) 202. For example, this can be seen from relation (2), where the relation of the received optical power h^{LED-LED}x to the photo-current yₑₗ^{LED-LED}(t) involves the time-dependent function g_{LED}(.,.). As mentioned above, during the k-th symbol period, (k−1)Tₛ≤t≤Tₛ, g_{LED} (.,.) is a monotonically decreasing function of time, typically strictly monotonically decreasing. As compared to that, the electrical output signal of the PD(s) 202 is time independent during the k-th symbol period, (k−1)Tₛ≤t≤Tₛ.

In the illustrated concepts, this issue can be efficiently considered by performing MIMO reception processing of the electrical output signals of the LED(s) 201 and the PD(s) 202 in the optical power domain instead of the photo-current domain. This will be further explained in the following.

The value of optical signal power collected from the receiving LED(s) 201 and PD(s) 202 can be estimated from the created photo-current. Accordingly, in the illustrated concepts the photocurrent of the LED(s) 201 and of the PD(s) may be processed to transform the photocurrent to an estimated optical power.

As can be seen from relation (1), for the PD(s) 202 such transformation can be achieved by dividing the photo-current by r, i.e., the responsivity of the PD 202. Specifically, the transformed received photo-current signal in the optical domain can be represented as:

$${y}_{op}^{LED - PD} = \frac{1}{r} {y}_{el}^{L E D - P D} , \qquad ( 4 )$$

and combination with relation (1) results in:

$${y}_{o p}^{L E D - P D} = {h}^{L E D - P D} x + {\tilde{w}}^{L E D - P D} , \qquad ( 5 )$$

where yₒₚ^{LED-PD} is the optical signal impinging on the considered PD 202, and

$${\tilde{w}}^{L E D - P D} = \frac{1}{r} {w}^{LED - PD}$$

represents additive noise, which can be modeled as a Gaussian random variable. It is noted that relations (4) and (5) represent one example of estimating the optical power received by the PD 202, and that it would also be possible to apply more sophisticated estimation mechanisms.

As regards the receiving LED(s) 201, transformation of the photo-current to the optical power domain also needs to consider the time-varying nature of the photocurrent. As mentioned above, the function g_{LED}(t,p) in (2) is typically a strictly monotonically decreasing function of time t during the signaling period (k−1)Tₛ≤t≤Tₛ. Here, p denotes the impinging optical power, i.e., h^{LED-LED}x. The function g_{LED}(t,.) may be considered as an implementation parameter and may for example be learnt by performing measurements on the LED 201. Such measurements do not need to be performed individually for each LED 201, but may be performed for a certain LED design, taking into account its intended deployment environment, e.g., the associated circuitry in the wireless communication device 200. With knowledge of g_{LED}(t,.), it is possible to determine its inverse function g_{LED}⁻¹(t,.).

Here, it is noted that various ways can be used to determine the inverse function g_{LED}⁻¹(t,.) For example, if g_{LED}(t,.) can be represented or approximated by a closed-form expression, the inverse function g_{LED}⁻¹(t,.) could be computed analytically from this closed-form expression. In other examples, g_{LED}(t,.) could be represented or approximated by a piece-wise linear function, i.e., g_{LED}(t,p)=Σₖ₌₁^{K}gₖ(t,p), where gₖ(t,p)=aₖp, for tₖ₋₁≤t≤tₖ and gₖ(t,p)=0 elsewhere. In this case, given that tₖ and aₖ can be considered as implementation parameters and be learned from measurements as mentioned above, and the inverse function g_{LED}⁻¹(t,.) can be expressed as:

$${g}_{L E D}^{- 1} ( t , . ) = {\sum }_{k = 1}^{K} {g}_{k}^{- 1} ( t , . ) . \qquad ( 6 )$$

Based on the inverse function g_{LED}⁻¹(t,.), the impinging optical power of the receiving LED 201 can be estimated as:

$${y}_{o p}^{L E D - L E D} = {g}_{L E D}^{- 1} ( t , {g}_{L E D} ( t , {h}^{L E D - L E D} x ) + {w}^{L E D - L E D} ) . \qquad ( 7 )$$

The transformation according to (7) may also be regarded as linearization of the electrical output signal of the receiving LED(s) 201.

As can be seen, the time dependency cancels out, yielding:

$${y}_{o p}^{L E D - L E D} = {h}^{L E D - L E D} x + {\tilde{w}}^{L E D - L E D} , \qquad ( 8 )$$

where \tilde{w}^{LED-LED}=g_{LED}⁻¹(w^{LED-LED}) represents the additive noise.

Based on (5) and (8), the optical power of the MIMO system can thus be expressed as:

$$[ \begin{matrix}{y}_{o p}^{L E D - L E D} \\ {y}_{op}^{L E D - P D}\end{matrix} ] = [ \begin{matrix}{H}^{L E D - L E D} \\ {H}^{L ED - PD}\end{matrix} ] x + [ \begin{matrix}{\tilde{w}}^{LED - LED} \\ {\tilde{w}}^{L E D - P D}\end{matrix} ] \qquad ( 9 )$$

where \tilde{w}^{LED-LED} and \tilde{w}^{LED-PD} are vectors representing the additive noise of the receiving LED(s) 201 and PD(s) 202. With

$${y}_{o p} = [ \begin{matrix}{y}_{o p}^{L E D - L E D} \\ {y}_{op}^{L E D - P D}\end{matrix} ] , H = [ \begin{matrix}{H}^{L E D - L E D} \\ {H}^{L ED - PD}\end{matrix} ] , and \tilde{w} = [ \begin{matrix}{\tilde{w}}^{LED - LED} \\ {\tilde{w}}^{L E D - P D}\end{matrix} ] ,$$

relation (8) can be expressed as:

$${y}_{o p} = H x + \tilde{w} , \qquad ( 10 )$$

which is similar to a system equation of conventional RF or optical MIMO systems. Consequently, once the measured received optical signal is transformed to the optical power domain, various known MIMO processing algorithms can be applied to the transformed signals, e.g., intensity-modulation MIMO algorithms known from conventional optical MIMO systems. For example, the incorporation of linear reception combining for the combination of LED(s) 201 and PD(s) 202 can be represented as:

$${\overline{y}}_{o p} = {Wy}_{o p} \qquad ( 11 )$$

where, W is a linear combiner applied on the estimate of the optical power as measured by (8), while, y̅ₒₚ is the linearized processed received signal. Here, it is noted that W can correspond to various known types of combiner, such as a Zero Forcing (ZF) combiner, a Minimum Mean Square Error (MMSE) combiner, or an ADR combiner. It can also be seen that the above solution may be applied irrespective of the individual characteristics of the receiving LED(s) 201 and PD(s) 202. Accordingly, the MIMO reception processing for one or more PDs and one or more LEDs may be performed in a unified way. Due to the application of the inverse function over the symbol period, the channel(s) corresponding to the receiving LED(s) 201 will appear slower than the channel(s) corresponding to the PD(s) 202. The unified operation of the receiving LED(s) 201 and PD(s) 202 may thus effectively be regarded as processing of parallel channels of different speed. The speed difference can be accommodated on higher layers.

In the above analysis, the photo-currents produced both by the receiving LED(s) 201 and the PD(s) 202 were transformed into optical power domain. It is however noted that in some scenarios the transformation could be omitted for the PD(s) 202, without substantially changing the form of relation (10), because for the PD(s) 202 the transformation of the photocurrent to the optical power domain is linear. It is possible also possible implement the MIMO reception processing based on a signal vector which includes one or more values of estimated optical power from the receiving LED(s) 201 and one or more values of measured photo-current from the PD(s) 202.

It is noted that the above principles of linearizing the electrical output signal of a receiving LED 201 using relation (7) may also be beneficial in scenarios where only LEDs are used to receive a MIMO OWC signal. An example of a corresponding scenario is illustrated in FIG. 2C. In the example of FIG. 2C, a receiving wireless communication device 200′ is equipped with N_{LED,rx} LEDs 201, without any PD. Similar to the example of FIG. 2B, the transmitting wireless communication device 210 is equipped with N_{LED,tx} LEDs 211. As further illustrated, the transmitting wireless communication device 210 may also be equipped with N_{PD,tx} PD 202. In such case, optical power of the MIMO system could be expressed as:

$${y}_{o p}^{L E D - L E D} = {H}^{L E D - L E D} x + {\tilde{w}}^{L E D} . \qquad ( 12 )$$

Again, it can be seen that also here the linearization allows for applying various kinds of known MIMO reception processing algorithms.

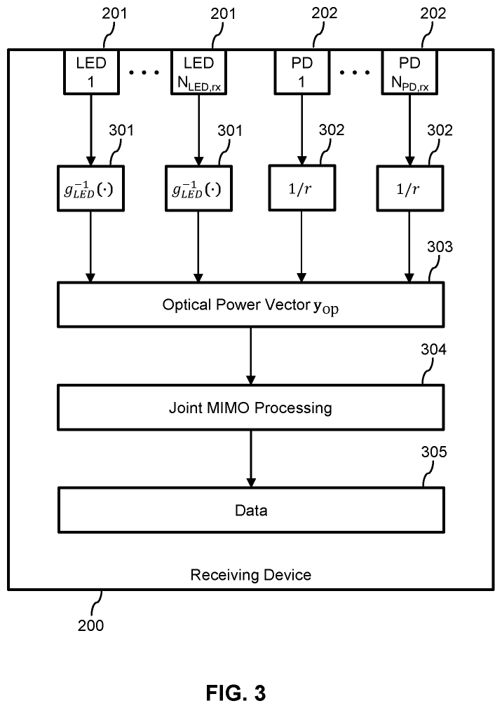

FIG. 3 shows a block diagram for schematically illustrating an example of MIMO reception processing in accordance with the illustrated concepts. Like explained in connection with the example of FIG. 2B, this example assumes that the receiving wireless communication device 200 is equipped with N_{LED,rx} receiving LEDs 201 and N_{PD,rx} PDs 202. As further illustrated, for each of the receiving LEDs 201, the electrical output signal generated in response to an impinging OWC signal is fed to a linearization block 301. The linearization block 301 applies the inverse function g_{LED}⁻¹(t,.) to the electrical output signal, thereby transforming the electrical output signal from the photocurrent domain to the optical power domain, as explained in connection with relation (7). Further, for each of the PDs 202, the electrical output signal generated in response to the impinging OWC signal is fed to a conditioning block 302. The conditioning block 302 divides the electrical output signal by the respective responsivity of the PD 202, as explained in connection with relation (4). The linearized and conditioned signals produced by the linearization blocks 301 and the conditioning blocks 302 are supplied to block 303, where they are combined to an optical power vector yₒₚ, as explained in connection with relations (9) and (10). At block 304, the optical power vector yₒₚ is used as input of joint MIMO reception processing to obtain data 305.

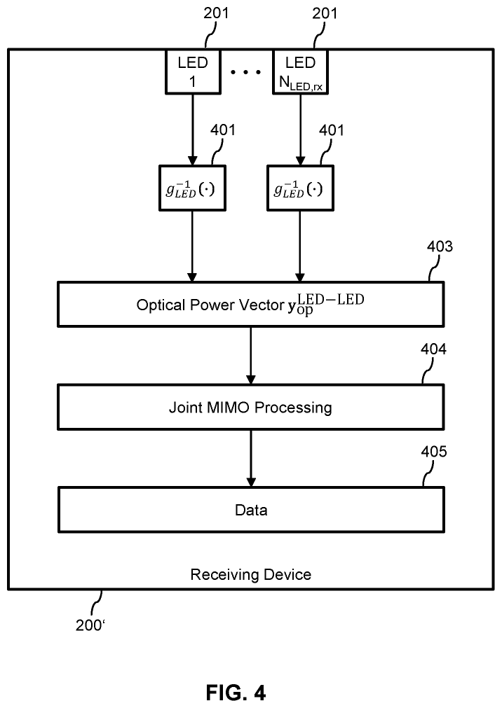

FIG. 4 shows a block diagram for schematically illustrating further example of MIMO reception processing in accordance with the illustrated concepts. Like explained in connection with the example of FIG. 2C, this example assumes that the receiving wireless communication device 200′ is equipped with N_{LED,rx} receiving LEDs 201, but no PDs. As further illustrated, for each of the receiving LEDs 201, the electrical output signal generated in response to an impinging OWC signal is fed to a linearization block 401. The linearization block 401 applies the inverse function g_{LED}⁻¹(t,.) to the electrical output signal, thereby transforming the electrical output signal from the photocurrent domain to the optical power domain, as explained in connection with relation (7). The linearized and conditioned signals produced by the linearization blocks 401 are supplied to block 403, where they are combined to an optical power vector yₒₚ^{LED-LED}, as explained in connection with relation (12). At block 404, the optical power vector yₒₚ^{LED-LED} is used as input of joint MIMO reception processing to obtain data 405.

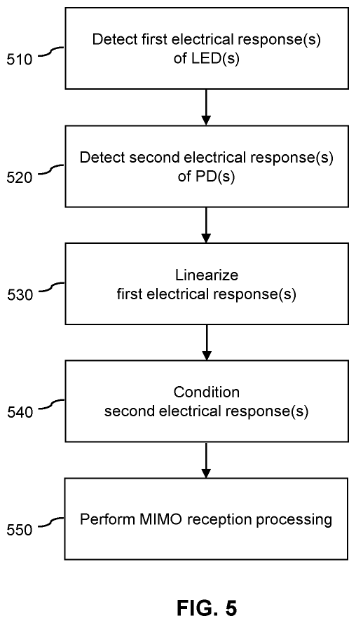

FIG. 5 shows a flowchart for illustrating a method, which may be utilized for implementing the illustrated concepts. The method of FIG. 5 may be used for implementing the illustrated concepts in a wireless communication device, such as the above-mentioned access node 100 or one of the above-mentioned MSs 11, or the above-mentioned receiving wireless communication device 200. The wireless communication device is assumed to be equipped with at least one PD and at least one LED. In some scenarios, the wireless communication device can be an IoT device.

If a processor-based implementation of the wireless communication device is used, at least some of the steps of the method of FIG. 5 may be performed and/or controlled by one or more processors of the wireless communication device. Such wireless communication device may also include a memory storing program code for implementing at least some of the below described functionalities or steps of the method of FIG. 5.

At step 510, the wireless communication device detects a first electrical response of the LED to an optical communication signal. The detected first electrical response may be based on a time-varying impulse response associated with discharging of an internal capacitance of the LED according to a function of time, e.g., like the above-mentioned function g_{LED}(t,.) in relation (2).

If the wireless communication device is equipped with multiple LEDs, step 510 may involve that the wireless communication device detects, for each of the multiple LEDs, a respective first electrical response of the LED to the optical communication signal.

At step 520, the wireless communication device detects a second electrical response of the PD to the optical communication signal. The detected second electrical response may be based on detecting a photocurrent generated in the PD. If the wireless communication device is equipped with multiple PDs, step 520 may involve that the wireless communication device detects, for each of the multiple PDs, a respective second electrical response of the LED to the optical communication signal.

At step 530, the wireless communication device may linearize the detected first electrical response(s). If the detected first electrical response is based on a time-varying impulse response associated with discharging of the internal capacitance of the LED according to a function of time, e.g., like the above-mentioned function g_{LED}(t,.) in relation (2), the linearization may involve applying an inverse of the function of time to the time-varying impulse response, e.g., as explained in connection with relation (7).

At step 540, the wireless communication device may condition the detected second electrical response(s). The detected second electrical response is based on detecting a photocurrent generated in the PD, the conditioning may involve dividing the detected photocurrent by a responsivity of the PD, e.g., as explained in connection with relation (4).

At step 550, the wireless communication device performs MIMO reception processing to receive data from at least one further wireless communication device. The MIMO reception processing is performed based on the first electrical response(s) detected at step 510, optionally as linearized at step 530, and the detected second electrical response(s) detected at step 520, optionally as conditioned at step 540. In some scenarios, e.g., in a multi-user MIMO scenario, the received data could also originate from multiple further wireless communication devices. For example, in the scenario of FIG. 1, the access node 100 could receive data from multiple MSs 11.

The MIMO reception processing of step 550 may be based on linear combining of the first electrical response(s) and the second electrical response(s). The MIMO reception processing may be based on an ZF algorithm, a MMSE algorithm, or an ADR algorithm.

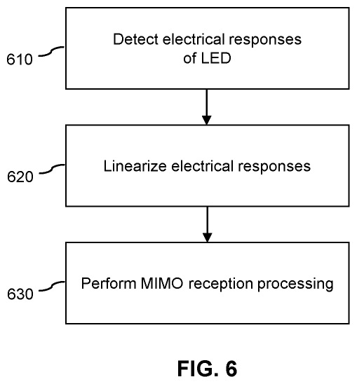

FIG. 6 shows a flowchart for illustrating a method, which may be utilized for implementing the illustrated concepts. The method of FIG. 6 may be used for implementing the illustrated concepts in a wireless communication device, such as the above-mentioned access node 100 or one of the above-mentioned MSs 11, or the above-mentioned receiving wireless communication device 200 or 200′. The wireless communication device is assumed to be equipped with multiple LEDs. In some scenarios, the wireless communication device may additionally be equipped with one or more PDs. In some scenarios, the wireless communication device can be an IoT device.

If a processor-based implementation of the wireless communication device is used, at least some of the steps of the method of FIG. 6 may be performed and/or controlled by one or more processors of the wireless communication device. Such wireless communication device may also include a memory storing program code for implementing at least some of the below described functionalities or steps of the method of FIG. 6.

At step 610, the wireless communication device detects, for each of the LEDs, a respective electrical response of the LED to an optical communication signal. The respective detected electrical response is based on a time-varying impulse response associated with discharging of an internal capacitance of the respective LED according to a function of time, e.g., like the above-mentioned function g_{LED}(t,.) in relation (2).

At step 620, the wireless communication device linearizes the detected electrical responses. The linearization involves applying an inverse of the function of time to the time-varying impulse response, e.g., as explained in connection with relation (7).

At step 630, the wireless communication device performs MIMO reception processing to receive data from at least one further wireless communication device. The MIMO reception processing is performed based on the electrical responses detected at step 610 and linearized at step 620. In some scenarios, e.g., in a multi-user MIMO scenario, the received data could also originate from multiple further wireless communication devices. For example, in the scenario of FIG. 1, the access node 100 could receive data from multiple MSs 11.

The MIMO reception processing of step 630 may be based on linear combining of the electrical response(s) and the second electrical response(s). The MIMO reception processing may be based on an ZF algorithm, a MMSE algorithm, or an ADR algorithm.

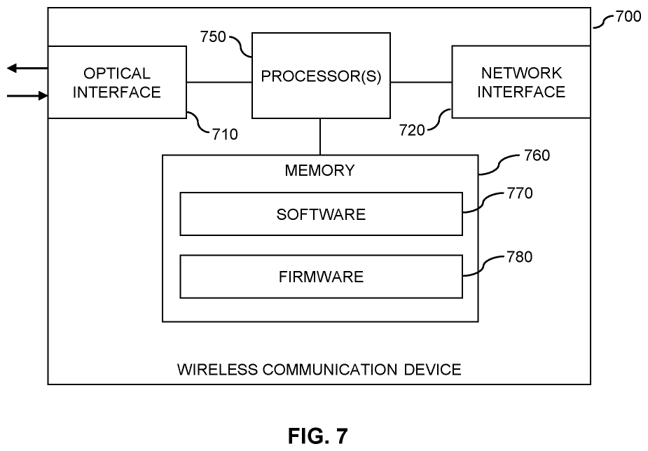

FIG. 7 illustrates a processor-based implementation of a wireless communication device 700. The structures as illustrated in FIG. 7 may be used for implementing the above-described concepts. The wireless communication device 700 may for example correspond to one of above-mentioned mentioned MSs 11, to the above-mentioned access node 100, to the above-mentioned wireless communication device 200, or to the above-mentioned wireless communication device 200′.

As illustrated, the wireless communication device 700 includes an optical interface 710. The optical interface may for example be based on an LC technology, e.g., operating in the visible and/or infrared spectrum. The optical interface 710 may be based on a combination of at least one LED and at least one PD. In some cases, the optical interface 710 could also be based on multiple LEDs, without any PD. Further, if the wireless communication device 700 corresponds to an access node, such as the above-mentioned access node 100, the wireless communication device 700 may also include a network interface 720, which may be used for communication with other nodes of the wireless communication network.

Further, the wireless communication device 700 includes one or more processors 750 coupled to the interface(s) 710, 720 and a memory 760 coupled to the processor(s) 750. By way of example, the interface(s) 710, 720, the processor(s) 750, and the memory 760 could be coupled by one or more internal bus systems of the wireless communication device 700. The memory 760 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 760 may include software 770 and/or firmware 780. The memory 760 may include suitably configured program code to be executed by the processor(s) 750 so as to implement the above-described functionalities for controlling wireless transmissions, such as explained in connection with FIG. 5 or 6.

It is to be understood that the structures as illustrated in FIG. 7 are merely schematic and that the wireless communication device 700 may actually include further components which, for the sake of clarity, have not been illustrated, e.g., further interfaces or further processors. Also, it is to be understood that the memory 760 may include further program code for implementing known functionalities of a mobile station, access node, or IoT device. According to some embodiments, also a computer program may be provided for implementing functionalities of the wireless communication device 700, e.g., in the form of a physical medium storing the program code and/or other data to be stored in the memory 760 or by making the program code available for download or by streaming.

As can be seen, the concepts as described above may be used for efficiently enhancing performance of OWC. Optical reception may be improved and a risk of optical blockage reduced, without requiring addition of a further PD. By using one or more LEDs as receiver, a larger optical MIMO receiver may formed as compared to a scenario where only PDs are used to receive OWC signals. Further, the illustrated concepts may efficiently enable joint processing, in particular MIMO reception processing, of optical signals collected by a combination of at least one LED and at least one PD, or collected by multiple LEDs. This may be possible irrespective of the different nature of the electrical responses of receiving LEDs and PDs to an impinging optical signal. In each case, it is possible to apply established MIMO reception algorithms, thereby enabling efficient implementation.

It is to be understood that the examples and embodiments as explained above are merely illustrative and susceptible to various modifications. For example, the illustrated concepts may be applied in connection with various kinds of OWC technologies. Further, the concepts may be applied with respect to various types of wireless communication devices. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-28. (canceled)

29. A method of controlling optical wireless communication, the method comprising:
a wireless communication device equipped with a photodetector (PD) and a light emitting diode (LED) detecting a first electrical response of the LED to an optical communication signal and a second electrical response of the PD to the optical communication signal; and
based on the detected first electrical response and the detected second electrical response, the wireless communication device performing Multiple Input and Multiple Output (MIMO) reception processing to receive data from at least one further wireless communication device,
wherein the detected first electrical response is based on a time-varying impulse response associated with discharging of an internal capacitance of the LED according to a function of time, the method further comprising:
the wireless communication device linearizing the detected first electrical response by applying an inverse of the function of time to the time-varying impulse response; and
the wireless communication device performing said MIMO reception processing based on the linearized first electrical response.

30. The method of claim 29, wherein the detected second electrical response is based on detecting a photocurrent generated in the PD.

31. The method of claim 30, further comprising:
the wireless communication device conditioning the detected second electrical response by dividing the detected photocurrent by a responsivity of the PD; and
the wireless communication device performing said MIMO reception processing based on the conditioned second electrical response.

32. The method of claim 29, wherein said MIMO reception processing is based on linear combining of the first electrical response and the second electrical response.

33. The method of claim 32, wherein said linear combining is based on a Zero Forcing algorithm, a Minimum Mean Square Error algorithm, or an angular diversity receiver algorithm.

34. The method of claim 29,
wherein the wireless communication device is equipped with multiple LEDs,
wherein, for each of the LEDs, the wireless communication device detects a respective first electrical response of the LED to the optical communication signal, and
wherein said MIMO reception processing is based on the detected first electrical responses and the detected second electrical response.

35. The method of claim 29,
wherein the wireless communication device is equipped with multiple PDs,
wherein, for each of the PDs, the wireless communication device detects a respective second electrical response of the PD to the optical communication signal, and
wherein said MIMO reception processing is based on the detected first electrical response and the detected second electrical responses.

36. The method of claim 29,
wherein the wireless communication device is equipped with multiple LEDs and multiple PDs,
wherein, for each of the LEDs, the wireless communication device detects a respective first electrical response of the LED to the optical communication signal,
wherein, for each of the PDs, the wireless communication device detects a respective second electrical response of the PD to the optical communication signal, and
wherein said MIMO reception processing is based on the detected first electrical responses and the detected second electrical responses.

37. The method of claim 29, wherein the wireless communication device is a mobile station.

38. The method of claim 29, wherein the wireless communication device is an Internet of Things device.

39. A method of controlling optical wireless communication, the method comprising:
a wireless communication device equipped with multiple light emitting diodes (LEDs) detecting, for each of the LEDs, a respective electrical response of the LED to an optical communication signal, wherein the electrical response is based on detecting a time-varying impulse response generated by discharging of an internal capacitance of the LED according to a monotonic function of time;
the wireless communication device linearizing each of the detected electrical responses by respectively applying an inverse of the monotonic function to the time-varying impulse response; and
based on the linearized electrical responses, the wireless communication device performing Multiple Input and Multiple Output (MIMO) reception processing to receive data from a further wireless communication device.

40. The method of claim 39,
wherein the wireless communication device is further equipped with a photodetector (PD),
wherein the wireless communication device detects a further electrical response of the at least one PD to the optical communication signal, and
wherein said MIMO processing is based on the linearized electrical responses and the further electrical response.

41. The method of claim 39, wherein the detected further electrical response is based on detecting a photocurrent generated in the PD.

42. The method of claim 41, further comprising:
the wireless communication device conditioning the detected further electrical response by dividing the detected photocurrent by a responsivity of the PD; and
the wireless communication device performing said MIMO reception processing based on the conditioned further electrical response.

43. The method of claim 39, wherein said MIMO reception processing is based on linear combining of the electrical responses.

44. The method of claim 43, wherein said linear combining is based on a Zero Forcing algorithm, a Minimum Mean Square Error algorithm, or an angular diversity receiver algorithm.

45. The method of claim 39,
wherein the wireless communication device is equipped with multiple PDs,
wherein, for each of the PDs, the wireless communication device detects a respective further electrical response of the PD to the optical communication signal, and
wherein said MIMO reception processing is based on the detected electrical response and the detected further electrical responses.

46. The method of claim 39, wherein the wireless communication device is a mobile station or an Internet of Things device.

47. A wireless communication device,
wherein the wireless communication device comprises a photodetector (PD) and a light emitting diode (LED) and comprises:
at least one processor, and
a memory containing program code executable by the at least one processor,
whereby execution of the program code by the at least one processor causes the wireless communication device to:
detect a first electrical response of the LED to an optical communication signal and a second electrical response of the PD to the optical communication signal; and
based on the detected first electrical response and the detected second electrical response, perform Multiple Input and Multiple Output (MIMO) reception processing to receive data from a further wireless communication device,
wherein the detected first electrical response is based on a time-varying impulse response associated with discharging of an internal capacitance of the LED according to a function of time, the wireless communication device being further configured to:
linearize the detected first electrical response by applying an inverse of the function of time to the time-varying impulse response; and
perform said MIMO reception processing based on the linearized first electrical response.

48. A wireless communication device,
wherein the wireless communication device comprises multiple light emitting diodes, LEDs, and comprises:
at least one processor, and
a memory containing program code executable by the at least one processor,
whereby execution of the program code by the at least one processor causes the wireless communication device to:
detect, for each of the LEDs, a respective electrical response of the LED to an optical communication signal, wherein the electrical response is based on detecting a time-varying impulse response generated by discharging of an internal capacitance of the LED according to a monotonic function of time;
linearize each of the detected electrical responses by respectively applying an inverse of the monotonic function to the time-varying impulse response; and
based on the linearized electrical responses, perform Multiple Input and Multiple Output (MIMO) reception processing to receive data from a further wireless communication device.
